(19) United States
(12) Patent Application Publication
(10) Pub. No.: US 2026/0135179 A1
(43) Pub. Date: May 14, 2026

(54) BATTERY RECYCLING PLANT AND PROCESS

(71) Applicant: BASF SE, Ludwigshafen am Rhein (DE)

(72) Inventors: Marc DUCHARDT, Ludwigshafen (DE); Maximilian RANG, Ludwigshafen (DE); Fabian SEELER, Ludwigshafen (DE); Wolfram WILK, Ludwigshafen (DE); Tobias ELWERT, Schwarzheide (DE); Anne-Marie Caroline ZIESCHANG, Ludwigshafen (DE); Wolfgang ROHDE, Ludwigshafen (DE); Kerstin SCHIERLE-ARNDT, Ludwigshafen (DE); Regina VOGELSANG, Ludwigshafen (DE)

(21) Appl. No.: 19/121,499

(22) PCT Filed: Oct. 31, 2023
(86) PCT No.: PCT/EP2023/080414

§ 371 Date: Apr. 16, 2025

(30) Foreign Application Priority Data
Nov. 3, 2022 (EP) 22205368.8

(51) Int. Cl. H01M 10/54; C22B 1/24; C22B 7/00; C22B 15/00; C22B 26/12

(52) U.S. Cl. CPC H01M 10/54; C22B 1/24; C22B 7/001; C22B 7/005; C22B 15/0056; C22B 26/12

(57) ABSTRACT

Disclosed herein are a plant for recycling used batteries, in particular lithium iron phosphate (LFP) batteries, and a process for recovering valuable materials from used batteries.

### FIELD OF THE INVENTION

The present disclosure relates to a plant for recycling used batteries, in particular lithium iron phosphate (LFP) batteries, and to a process for recovering valuable materials from used batteries.

### BACKGROUND

Lithium iron phosphate battery materials are complex mixtures of various elements and compounds. For example, many lithium iron battery materials contain valuable metals such as lithium, aluminum, and copper. It may be desirable to recover various elements and compounds from lithium iron battery materials. For example, it may be advantageous to recover lithium and/or copper. Accordingly, there is a need for devices and processes for recycling used batteries.

DE 10 2015 207 843 A1 discloses a recycling plant for used batteries. The batteries are pretreated in a complex manner, in particular discharged and dismantled, before they are comminuted and dried. This increases the operating costs of the device, in particular because of the labor required.

CN 111 495 925 A discloses a waste lithium battery pyrolyzation, defluorination and dechlorination method. The method comprises the steps of discharging and dismantling waste lithium batteries; conducting primary crushing, drying a crushed product, conducting primary separation on the dried crushed product, conducting secondary crushing and secondary separation, conducting pyrolyzation, defluorination, dechlorination and in-situ fluorine and chlorine absorption on a separated material, scattering and screening a pyrolyzed product to obtain black powder, conducting washing and separation on copper and aluminum foil to obtain copper and aluminum products, pyrolyzing and drying flue gas, conducting condensing, dust removal, spraying, adsorption and ignition on the flue gas, and then discharging the flue gas. Pyrolyzation, defluorination, dechlorination and in-situ fluorine and chlorine absorption are conducted in an airtight rotary kiln. The airtight rotary kiln comprises three layers, the inner layer comprising an absorbing agent, the middle layer comprising a pyrolyzation material layer, and the outer layer comprising a heating layer.

ZHENG, Rujuan et al.: “Optimized Li and Fe recovery from spent lithium-ion batteries via a solution-precipitation method”, RSC Advances vol. 6, no. 49 (2016) pp. 43613-43625 discloses a process for recovery of iron phosphate and lithium carbonate from waste lithium iron phosphate batteries. The process includes the following steps: (1) after crushing the discharged battery, recycle the membrane, battery shell and copper content, (2) heat treatment of the anode at 600° C., sieving with a 0.5 mm sieve, (3) dissolving the powder in 2.5 mol/L sulfuric acid with L/S equal to 10, a temperature of 60° C. and a time of 4 hrs, (4) causing precipitation of iron phosphate with PEG-600 as surfactant at a pH of 2, (5) precipitation of sodium carbonate and lithium carbonate be concentrating the filtrate and heating it to the boiling point, (6) mixing the recycled iron phosphate and lithium carbonate and sucrose at a molar ratio of lithium, iron and phosphorus of 1.05:1:1, ball-milling and drying the mixture, (7) pre-sintering the mixture under argon at 350° C. and calcining it at a temperature of 750° C. for 10 hrs to obtain a cathode material.

EP 3 641 036 A1 relates to a plant for recycling used batteries, comprising a comminuting device to comminute used batteries in a comminuting space. The plant includes a drying device, arranged downstream of the comminuting device, to dry the comminuted batteries. The plant includes an intermediate storage device arranged between the comminuting device and the drying device. The plant includes a stirring means to keep the comminuted batteries received in the intermediate storage space in motion. The plant includes a respective supply line for inert gas for each of the comminuting space of the comminuting device, the intermediate storage space of the intermediate storage device, and a drying space of the drying device.

It is an object of the present disclosure to provide an improved recycling plant for used lithium iron phosphate (LFP) batteries and an improved recycling process for used lithium iron phosphate (LFP) batteries.

### SUMMARY OF THE INVENTION

A plant for recycling lithium iron phosphate (LFP) battery materials is provided which comprises a comminuting device to comminute LFP battery material in a comminuting space. The plant includes a drying device, arranged downstream of the comminuting device, to dry the comminuted LFP battery material. The plant includes an intermediate storage device arranged between the comminuting device and the drying device. The volume of an intermediate storage space of the intermediate storage device is at least five times, preferably at least ten times, the volume of the comminuting space of the comminuting device. The intermediate storage device further comprises a stirring means which is designed and intended to keep the comminuted LFP battery material received in the intermediate storage space in motion. The plant includes a pyrolysis device, arranged downstream of the drying device and comprising a pyrolysis space. In some embodiments, the plant includes a respective supply line for inert gas for each of the comminuting space of the comminuting device, the intermediate storage space of the intermediate storage device, a drying space of the drying device, and the pyrolysis space of the pyrolysis device.

A process for recycling LFP battery material also is provided. The process comprises providing LFP battery material to a comminuting device, comminuting the LFP battery material in the comminuting device, transferring the comminuted LFP battery material into a drying device, drying the comminuted LFP battery material, transferring the comminuted and dried LFP battery material into a pyrolysis device, heating the comminuted and dried LFP battery material to a temperature of from 400° C. to 630° C. while contacting the comminuted and dried LFP battery material with an inert gas and with a reductive gas generated in situ by thermal decomposition of the comminuted and dried LFP battery material to obtain a pyrolyzed battery material.

### BRIEF DESCRIPTION OF THE DRAWINGS

FIG. 1 is a schematic representation of an exemplary recycling plant according to the present disclosure.

### DEFINITIONS

In the present disclosure, the term “battery” not only encompasses non-rechargeable primary cells, but also accumulators, i.e. rechargeable energy storage cells. In particular, the device of the present disclosure is suitable for processing rechargeable and non-rechargeable storage cells which comprise lithium, in particular lithium compounds and/or lithium ions, and are referred to very generally in the present application as “LFP batteries”.

Furthermore, in the present disclosure, the term “drying” is also used for the removal, in particular evaporation, of the electrolyte, for example dimethyl carbonate (DMC), diethylcarbonate (DEC), and/or ethyl methyl carbonate (EMC). Although it does not only relate to the removal of liquid substances, but can also relate to the removal of solids, the term “drying” has become common in technical language for this purpose.

### DETAILED DESCRIPTION

A plant for recycling LFP battery material is provided which comprises a comminuting device to comminute LFP battery material in a comminuting space. The plant includes a drying device, arranged downstream of the comminuting device, to dry the comminuted LFP battery material.

The plant includes an intermediate storage device arranged between the comminuting device and the drying device. The volume of an intermediate storage space of the intermediate storage device is at least five times, preferably at least ten times, the volume of the comminuting space of the comminuting device. The intermediate storage device further comprises a stirring means which is designed and intended to keep the comminuted LFP battery material received in the intermediate storage space in motion. The intermediate storage device assumes multiple functions in the plant according to the disclosure.

Firstly, the intermediate storage allows for electrochemical reactions taking place in the comminuted material to subside to an extent that they do not create problems when the comminuted material is supplied to the drying device.

In addition, the intermediate storage device serves as a temporary store for comminuted material. In this way, the plant of the present disclosure can be operated in a batch-wise manner, such that only small amount of LFP battery material needs to be supplied to the comminuting device in each batch, while a larger amount of comminuted material can be supplied to the drying device at once. Due to the small amount of material to be comminuted in one step, the risk of self-ignition can be practically excluded. This is particularly advantageous because the used LFP batteries in the plant of the present disclosure that are supplied to the comminuting device may not have been pre-discharged or at least not completely pre-discharged, and the residual charge of the LFP batteries, which drives the electrochemical reactions, is unknown.

And finally, freshly comminuted LFP battery material entering the intermediate storage space from the comminuting device is mixed by the stirring means with comminuted material that was previously brought into the intermediate storage space, in which material the electrochemical reactions have at least partially subsided. This helps to avoid the formation of partial volumes of impermissibly high temperature having an increased risk of self-ignition.

In order to further reduce the risk of self-ignition, an inert gas is additionally supplied to the comminuting device and the intermediate storage device and the drying device, i.e., a gas that at least counteracts, if not even prevents, self-ignition of the comminuted batteries while the electrochemical reactions are taking place. For example, nitrogen gas and/or carbon dioxide gas can be used as the inert gas.

All of these measures ensure that in the plant according to the disclosure, substantially unprepared LFP batteries, in particular LFP batteries that are not or at least not completely pre-discharged and dismantled, can be recycled in a substantially automated and therefore cost-effective process.

In an exemplary plant, 1 ton of LFP battery material per hour can be recycled. LFP battery materials are supplied to the comminuting device in the form of ten batches of 100 kg and temporarily stored in the intermediate storage device before they are passed on to the drying device. In one embodiment, the comminuting space volume of the comminuting device is approximately 0.5 m³ and/or the intermediate storage space volume of the intermediate storage device is approximately 6.0 m³ and/or the drying space volume of the drying device is approximately 3.0 m³. It has to be taken into account that the comminuted material is compacted by the conveying device, for example, a pipe screw conveyor, which transports the material from the homogenizing device to the drying device.

In order to prevent environmentally incompatible or even dangerous gases from escaping from the battery recycling plant, it is proposed in a further embodiment of the plant that the comminuting space and/or the intermediate storage space and/or the drying space are gas-tight.

In a further embodiment, the transfer device for transferring the comminuted LFP battery material from the comminuting device to the intermediate storage device and/or the transfer device for transferring the comminuted LFP battery material from the intermediate storage device to the drying device is gas-tight and connected to the devices adjoining same in a gas-tight manner.

In a further embodiment, an exhaust gas treatment device is provided which is connected to the comminuting space and/or the intermediate storage space and/or the drying space via gas supply lines and is configured to process the gases formed in the comminuting space and/or in the intermediate storage space and/or in the drying space. The person skilled in the art is familiar with the components that the exhaust gas treatment device can or should comprise depending on the gas components produced. For this reason, a detailed discussion of the design and function of the exhaust gas treatment device can be dispensed with at this point.

In order to further reduce the risk from the recycling plant, a deep-freezing device is arranged upstream of the comminuting device in a further embodiment of the plant. The deep-freezing device comprises a feed line for a liquid deep-freezing medium and is configured to deep-freeze the used batteries in the liquid deep-freezing medium before they are comminuted in the comminuting device.

Liquefied inert gas, in particular, liquid nitrogen and/or liquid carbon dioxide, can be used as the liquid deep-freezing medium. In this case, a gas head space of the deep-freezing device can also be connected to the supply line for inert gas. In this way, the deep-freezing medium evaporating due to the energy input from the used LFP battery material can be used as an inert gas in the comminuting device and/or in the intermediate storage device and/or in the drying device.

In order to prevent excessively large fragments of the comminuted LFP battery material from exiting the comminuting device in the direction of the intermediate storage device, a sieve unit, for example a perforated sieve, is arranged at the outlet of the comminuting device in a further embodiment of the plant. In one embodiment, the openings of the sieve unit have a diameter of 20 mm. For instance, a universal shredder of the type NGU 0513, as sold by BHS Sonthofen GmbH, Germany, can be used as the comminuting device.

In order to ensure that the temperature in the intermediate storage space does not exceed a critical temperature value, for example 120° C., a cooling device is assigned to the intermediate storage device in some embodiments of the plant.

In some embodiments, the cooling device takes the form of cooling tubes attached to a wall surrounding the intermediate storage space, which are in heat-exchange contact with the wall and through which, if necessary, cooling medium can flow.

In a further embodiment, the drying device is a negative-pressure drying device and has a pressure control unit which maintains the pressure in the drying space at a value of approximately 50 hPa. In a further embodiment, the drying device has a temperature control unit which maintains the temperature in the drying space at a value of from approximately 100° C. to approximately 120° C.

A pyrolysis device is arranged downstream of the drying device. The pyrolysis device is configured to receive the comminuted and dried LFP battery material from the drying device and subject it to a heat treatment in a pyrolysis space provided within the pyrolysis device. In some embodiments, the pyrolysis device includes a supply line for supplying inert gas and/or a reductive gas to the pyrolysis space of the pyrolysis device. In some embodiments of the plant, the pyrolysis device comprises an oven, for instance, an electric oven.

In some embodiments of the plant, the pyrolysis device comprises a rotary kiln. The rotary kiln is a cylindrical vessel, inclined slightly from the horizontal, which is rotated slowly about its longitudinal axis. The process feedstock is fed into the upper end of the cylinder. As the kiln rotates, material gradually moves down toward the lower end, and may undergo a certain amount of stirring and mixing.

In some embodiments of the plant, the kiln has a length in the range of from 12 to 18 m. In some embodiments of the plant, the kiln has a length in the range of from 15 to 17 m. Kiln length refers to the length of the heated zone of the kiln. Additional elements will make the overall kiln a little bit longer. In some embodiments of the plant, the inner diameter of the cylindrical tube is in the range of from 1.5 m to 2.1 m, e.g., from 1.7 m to 1.9 m.

In some embodiments of the plant, the rotary kiln features external heating elements using electric power. In some embodiments, the kiln comprises several heating zones. In some embodiments, each and every heating zone is configured to operate at a temperature in the range of from 400° C. to 650° C., e.g., from 520° C. to 600° C. In some embodiments, thermoelements are provided in each of the heating zones for measuring the temperature in the respective zone. In one embodiment, each heating zone has a length of from 0.5 m to 6 m, e.g., from 1 m to 4 m, for instance, from 1.5 m to 3 m.

In some embodiments of the plant, the kiln connects with a material exit hood at the lower end and ducts for waste gases, and features gas-tight seals at both ends of the kiln. Equipment is installed to eliminate hydrocarbons from the exhaust gas stream of the kiln before passing the exhaust gas into the atmosphere.

An oxidation device is arranged downstream of the pyrolysis device. The oxidation device is configured to receive the pyrolyzed LFP battery material from the pyrolysis device and subject it to oxidative roasting in an oxidation space provided within the oxidation device to produce oxidized LFP battery material. In some embodiments, the oxidation device includes a supply line for supplying oxygen-containing gas to the oxidation space of the oxidation device. In some embodiments of the plant, the oxidation device comprises an oven, for instance, a furnace or a kiln.

In some embodiments of the plant, the pyrolysis device comprises at least one rotary kiln. In some embodiments of the plant, the rotary kiln is a directly heated kiln comprising at least one burner arranged inside the kiln.

In some embodiments of the plant, a filling device is arranged downstream of the oxidation device. The filling device provides the oxidized LFP battery material for further processing. In some embodiments, the oxidized LFP battery material is filled into transport containers in this filling device.

In some embodiments, at least one screening device, preferably arranged upstream of the filling device, is arranged downstream of the comminuting device. In this screening device, the individual components of the comminuted and dried LFP batteries can be separated from one another and thus supplied to a more targeted processing. In some embodiments, at least one screening device, preferably arranged upstream of the filling device, is arranged downstream of the oxidation device. In this screening device, the material obtained from the oxidation device can be separated into fractions having different particle sizes, and the fractions can be supplied to a more targeted downstream processing. In some embodiments, at least one screening device, is arranged upstream of the pyrolysis device and at least one screening device is arranged downstream of the oxidation device.

The present disclosure also provides a process for recycling LFP battery material. The process comprises
a) providing LFP battery material to a comminuting device,
b) comminuting the LFP battery material in the comminuting device,
c) transferring the comminuted LFP battery material into a drying device,
d) drying the comminuted LFP battery material,
e) transferring the comminuted and dried LFP battery material into a pyrolysis device,
f) heating the comminuted and dried LFP battery material to a temperature of from 400° C. to 630° C. while contacting the comminuted and dried LFP battery material with an inert gas and with a reductive gas generated in situ by thermal decomposition of the comminuted and dried LFP battery material to obtain a pyrolyzed LFP battery material;
g) oxidizing the pyrolyzed LFP battery material at a temperature in the range of rom 400° C. to 600° C., e.g., from 450° C. to 550° C., for instance, from 470° C. to 530° C., while contacting the pyrolyzed LFP battery material with an oxygen-containing gas to obtain an oxidized LFP battery material.

At the start of the process, used LFP battery material is provided to a comminuting device and then comminuted in the comminution device.

In some embodiments of the process, the LFP battery material is at least one chosen from a lithium iron phosphate battery, lithium iron phosphate battery waste, lithium iron phosphate battery production scrap, lithium iron phosphate cell production scrap, lithium iron phosphate cathode active material, and combinations thereof.

Lithium iron phosphate batteries may be disassembled, punched, milled, for example in a hammer mill, rotor mill, and/or shredded, for example in an industrial shredder. From this kind of mechanical processing, the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used LFP batteries or from production waste such as off-spec material. In some embodiments a material is obtained from mechanically treated LFP battery scraps, for example from LFP battery scraps treated in a hammer mill a rotor mill or in an industrial shredder.

Larger parts of the LFP battery scrap like the housings, the wiring and the electrode carrier films may be separated mechanically such that the corresponding materials may be excluded from the used LFP batteries employed in the process of the present disclosure. In some embodiments, the separation is done by manual or automated sorting. For example, magnetic parts can be separated by magnetic separation; non-magnetic metals can be separated by eddy-current separators. Other techniques may comprise jigs and air tables.

In some embodiments of the process, step b) comprises the steps of:
I. feeding the material to a first comminuting device and comminuting the material to obtain first particles having a maximum diameter of 50 mm or less;
II. feeding the first particles obtained in step I) to a second comminuting device and comminuting the first particles to obtain second particles having a maximum diameter of 20 mm or less;
III. feeding the second particles obtained in step II) to a first separating device to remove a first fine fraction consisting of particles having a size of <500 μm from the second particles;
IV. feeding the second particles obtained in step III) to a third comminuting device and comminuting the second particles to generate a second fine fraction consisting of particles having a size of <500 μm;
V. combining the first fine fraction and the second fine fraction.

The first and the second fine fraction, respectively, consist of particles having a size of <500 μm. In other words, all particles of the first and the second fine fraction, respectively, will pass through a sieve having a mesh width of 500 μm.

In some embodiments, step V. involves sieving the first fine fraction and the second fine fraction through a sieve having a mesh width of not more than 500 μm, e.g., 250 μm or less. In some embodiments, the particles remaining on the sieve are washed with water to remove residual fine fraction adhering to the particles remaining on the sieve.

The comminuted LFP battery material is transferred into a drying device and dried. In some embodiments of the process, the comminuted and dried LFP battery material comprises an aluminum foil and a cathode active material.

In some embodiments, the comminuted and dried LFP battery material comprises copper, aluminum, lithium, iron, phosphorus, or combinations thereof.

In some embodiments, the comminuted and dried LFP battery material comprises from 1 to 50 wt.-%, e.g., from 20 to 45 wt.-%, for instance, from 30 to 40 wt.-% carbon, relative to the total weight of the comminuted and dried LFP battery material.

In some embodiments, the comminuted and dried LFP battery material comprises from 0.1 to 10 wt.-%, e.g., from 1 to 7 wt.-%, for instance, from 2 to 4 wt.-% aluminum, relative to the total weight of the comminuted and dried LFP battery material.

In some embodiments, the comminuted and dried LFP battery material comprises from 0.5 to 7 wt.-%, e.g., from 1 to 5 wt.-%, for instance, from 1.5 to 3 wt.-% copper, relative to the total weight of the comminuted and dried LFP battery material.

In some embodiments, the comminuted and dried LFP battery material comprises from 0 to 11 wt.-%, e.g., from 1 to 7 wt.-%, for instance, from 2 to 5 wt.-% manganese, relative to the total weight of the comminuted and dried LFP battery material.

In some embodiments, the comminuted and dried LFP battery material comprises from 1 to 7 wt.-%, e.g., from 1.5 to 5 wt.-%, for instance, from 2 to 4 wt.-% lithium, relative to the total weight of the comminuted and dried LFP battery material.

In some embodiments, the comminuted and dried LFP battery material comprises from 10 to 35 wt.-%, e.g., from 12.5 to 25 wt.-%, for instance, from to 20 wt.-% iron, relative to the total weight of the comminuted and dried LFP battery material.

In some embodiments, the comminuted and dried LFP battery material comprises from 1 to 7 wt.-%, e.g., from 1.5 to 5.5 wt.-%, for instance, from 2 to 4 wt.-% fluorine, relative to the total weight of the comminuted and dried LFP battery material.

In some embodiments, the comminuted and dried LFP battery material comprises from 5 to 20 wt.-%, e.g., from 7 to 16 wt.-%, for instance, from 9 to 12 wt.-% phosphorus, relative to the total weight of the comminuted and dried LFP battery material.

The sum of the weight fractions of C, Al, Cu, Mn, Li, Fe, P, F of the comminuted and dried LFP battery material is less than or equal to 100 wt.-%.

The comminuted and dried LFP battery material is transferred into a pyrolysis device and subsequently heated to a temperature of from 400° C. to 630° C. while contacting the comminuted and dried LFP battery material with an inert gas and with a reductive gas generated in situ by thermal decomposition of the comminuted and dried LFP batteries to obtain a pyrolyzed LFP battery material.

In some embodiments, the process of the present disclosure comprises providing comminuted and dried LFP battery material at a first temperature; heating the comminuted and dried LFP battery material at a second temperature ranging from 400° C. to 630° C., e.g., from 520° C. to 630° C., for instance, from 550° C. to 600° C.; contacting the comminuted and dried LFP battery material with an inert gas and with a reductive gas generated in situ by thermal decomposition of the comminuted and dried LFP battery material to obtain a pyrolyzed LFP battery material; oxidizing the pyrolyzed LFP battery material at a temperature in the range of from 400° C. to 600° C., e.g., from 450° C. to 550° C., to obtain an oxidized LFP battery material, and optionally cooling the a oxidized LFP battery material to a third temperature ranging from 10° C. to 100° C., e.g., from 20° C. to 70° C.

In some embodiments, the process of the present disclosure comprises providing comminuted and dried LFP battery material at a first temperature. In some embodiments of the process, the first temperature ranges from −50° C. to 50° C., e.g., from −10° C. to 40° C., for instance, from 0° C. to 30° C. In a particular embodiment, the first temperature is ambient temperature.

In some embodiments of the process, calcium carbonate is added to the comminuted and dried LFP battery material prior to transferring it into the heat treatment device. In some embodiments, a stoichiometric amount of calcium carbonate, relative of the total fluorine content of the comminuted and dried LFP battery material, is added. For each mol of fluorine present, 0.5 mol of calcium carbonate are added. During heat treatment of the comminuted and dried LFP battery material, the calcium carbonate reacts with fluorine present in the comminuted LFP battery material, thus trapping fluorine and preventing the formation of corrosive and toxic gases like hydrogen fluoride.

In some embodiments of the process, a mixture of calcium carbonate and magnesium carbonate is added to the comminuted and dried LFP battery material prior to transferring it into the heat treatment device. In some embodiments, a stoichiometric amount of the calcium carbonate/magnesium carbonate mixture, relative of the total fluorine content of the comminuted and dried LFP battery material, is added. For each mol of fluorine present, the molar amount calcium carbonate and magnesium carbonate added sums up to 0.5 mol (x mol CaCO₃+y mol MgCO₃=0.5 mol (CaCO₃+MgCO₃). In some embodiments, dolomite (CaMg(CO₃)₂) is added to the comminuted and dried LFP battery material prior to transferring it into the heat treatment device. During heat treatment of the comminuted and dried LFP battery material, the calcium carbonate/magnesium carbonate mixture reacts with fluorine present in the comminuted and dried LFP battery material, thus trapping fluorine and preventing the formation of corrosive and toxic gases like hydrogen fluoride. It has been found that using a mixture of calcium carbonate and magnesium carbonate further increases the leaching efficiency for lithium and reduces the amount of iron in the leach solution.

In some embodiments, the process of the present disclosure comprises heating the comminuted and dried LFP battery material at a second temperature ranging from 400° C. to 630° C., e.g., from 520° C. to 630° C. In some embodiments of the process, the second temperature ranges from 530° C. to 600° C. In further embodiments, the second temperature ranges from 550° C. to 580° C.

In some embodiments of the process, the heating step comprises a temperature ramp from the first temperature to the second temperature over a period of 10 minutes to 2 hours. In some embodiments of the process, the heating step comprises a temperature ramp from the first temperature to the second temperature over a period of 30 minutes to 1 hour.

In some embodiments, a temperature ramp has average rate of temperature increase of at least 5 K per minute. In some embodiments, a temperature ramp has average rate of temperature increase of at least 10 K per minute. In some embodiments, a temperature ramp has average rate of temperature increase of at least 15 K per minute. In some embodiments, a temperature ramp has average rate of temperature increase of at least 20 K per minute. In some embodiments, a temperature ramp has average rate of temperature increase of at least 25 K per minute. In some embodiments, a temperature ramp has average rate of temperature increase of up to 50 K per minute.

In some embodiments, a temperature ramp has average rate of temperature increase ranging from 5 K per minute to 50 K per minute. In some embodiments, a temperature ramp has average rate of temperature increase ranging from 10 K per minute to 50 K per minute.

In some embodiments of the process, the heating step comprises dwelling at the second temperature for a period of time ranging from 0 minutes to 1 hour, for instance, from 10 minutes to 45 minutes, or from 15 minutes to 30 minutes.

In some embodiments of the process, the heating step comprises dwelling at one or more intermediate temperatures ranging from the first temperature to the second temperature.

In some embodiments, the process of the present disclosure comprises: providing comminuted and dried LFP battery material at a first temperature ranging from −50° C. to 50° C.; heating the comminuted and dried LFP battery material at a second temperature ranging from 520° C. to 600° C.; wherein the heating step comprises a temperature ramp from the first temperature to the second temperature over a period of time ranging from 10 minutes to 1 hour; dwelling at the second temperature for a time ranging from 0 minutes to 1 hour; and, optionally, cooling the material to a third temperature ranging from 50° C. to 70° C.

The process of the present disclosure comprises contacting the comminuted and dried LFP battery material with an inert gas and with a reductive gas generated in situ by thermal decomposition of the comminuted and dried LFP battery material to obtain a pyrolyzed LFP battery material.

In some embodiments, the flow rate of the inert gas is in the range of from 100 to 300 Sm³/h, e.g. 150 to 250 Sm³, for instance, 200 Sm³/h (standard cubic meter per hour).

In some embodiments, the inert gas comprises at least one gas chosen from argon (Ar), dinitrogen (N₂), helium (He), and mixtures thereof.

In some embodiments, the reductive gas comprises at least one gas chosen from the group of hydrocarbons, dihydrogen gas (H₂), carbon monoxide (CO), and mixtures thereof.

In some embodiments of the process, the reductive gas comprises: from 5 volume % to 70 volume % C₁ to C₁₀ hydrocarbons, from 5 volume % to 95 volume % carbon dioxide (CO₂), from 0.1 volume % to 10 volume % carbon monoxide (CO), and from 0.1 volume % to 15 volume % H₂; wherein each volume % is by total volume of the reductive gas and the volume % of C₁ to C₁₀ hydrocarbons plus the volume % of CO₂ plus the volume % of H₂ is less than or equal to 100%.

In some embodiments of the process, the reductive gas comprises: from 5 volume % to 70 volume % C₁ to C₁₀ hydrocarbons, from 5 volume % to 45 volume % C₁ to C₁₀ oxy-hydrocarbons, and from 0.1 volume % to 15 volume % H₂; wherein each volume % is by total volume of the reductive gas and the volume % of C₁ to C₁₀ hydrocarbons plus the volume % C₁ to C₁₀ oxy-hydrocarbons plus the volume % of H₂ is less than or equal to 100%.

In some embodiments of the process, the heating step is performed in a rotary kiln. In some embodiments of the process, the kiln is filled with a volume of comminuted and dried LFP battery material equal to 5 to 20%, e.g., from 7% to 16%, for instance, from 9% to 12%, of the total volume of the kiln.

In some embodiments of the process, the comminuted and dried LFP battery material are fed to the kiln using at least one screw conveyor.

In some embodiments of the process, the kiln rotates at 0.5 rpm to 3 rpm. In some embodiments of the process, the kiln rotates at 1.4 rpm to 2.6 rpm. In some embodiments of the process, the kiln rotates at 1.8 rpm to 2.2 rpm.

In some embodiments of the process, overpressure is maintained in the kiln during operation to prevent air from entering the kiln.

In some embodiments of the process, hot gases pass along the kiln in the same direction as the process material (concurrent). In some embodiments of the process, the comminuted and dried LFP battery material and an inert gas are fed to the rotary kiln in concurrent flow. The concurrent flow makes sure that no dust emerges from the upper end of the kiln.

In some embodiments of the process, the rotary kiln is heated by external heating elements using electric power. In some embodiments of the process, the kiln comprises several heating zones. In some embodiments of the process, each and every heating zone is operated at a temperature in the range of from 400° C. to 630° C., e.g., from 520° C. to 600° C.

The pyrolyzed LFP battery material is transferred into an oxidation device and subsequently heated at a temperature in the range of from 400° C. to 600° C., e.g., from 450° C. to 550° C., for instance, from 470° C. to 530° C., while contacting the pyrolyzed battery material with an oxygen-containing gas to obtain an oxidized LFP battery material.

In some embodiments, the pyrolyzed LFP battery material is transferred directly from the outlet of the pyrolysis device to the inlet of the oxidation device, so that the temperature of the pyrolyzed battery material does not decrease substantially, e.g., by not more than 150 K, for instance, not more than 100 K.

The pyrolyzed LFP battery material is heated at a temperature in the range of from 400° C. to 600° C., e.g., from 450° C. to 550° C., for instance, from 470° C. to 530° C., in the oxidation device. In some embodiments of the process, the oxidation step comprises dwelling at the temperature for a period of time ranging from 0 minutes to 2 hours, for instance, from 10 minutes to 90 minutes, or from 15 minutes to 45 minutes.

During treatment in the oxidation device, the pyrolyzed LFP battery material is contacted with an oxygen-containing gas. In some embodiments of the process, the oxygen-containing gas is air. In some embodiments of the process, the oxygen-containing gas is lean air, i.e., a mixture of nitrogen and oxygen having an oxygen content of less than 20.95 vol %. In some embodiments of the process, lean air having an oxygen content of less than 8 vol %, e.g., less than 5 vol %, for instance, 1 to 3 vol %, is used. In some embodiments of the process, the oxygen-containing gas has an oxygen content of more than 21 vol %.

In some embodiments, the flow rate of the oxygen-containing gas is in the range of from 200 to 3000 Sm³/h, e.g. 700 to 900 Sm³/h, or 2000 to 2500 Sm³/h (standard cubic meter per hour).

In some embodiments, the oxidized LFP battery material comprises Li₃Fe₂(PO₄)₃ and Fe₂O₃ in a molar ratio of approximately 2:1, for instance, in a range from 1.8:1 to 2.2:1.

In some embodiments, the process of the present disclosure involves cooling the oxidized LFP battery material obtained to a third temperature ranging from 10° C. to 100° C., e.g., from 20° C. to 50° C. In some embodiments, cooling is performed in a rotary cooler positioned at the lower end of the rotary kiln. In some embodiments, the rotary cooler has the same diameter as the rotary kiln and is cooled by a water jacket.

As provided herein, different process parameters may produce oxidized LFP battery materials having different compositions and/or properties. Oxidized LFP battery materials having, for example, a favorable composition, mechanical properties, surface hydrophilicity, and/or porosity may, e.g., result in improved processibility and/or recovery in subsequent downstream processing steps.

The present disclosure also provides a use of the oxidized LFP battery material of the present disclosure in the recovery of valuable materials from used LFP batteries. In some embodiments, the oxidized LFP battery material is used as an intermediate for a downstream leaching process.

For example, the oxidized LFP battery material can be leached with an acidic aqueous solution comprising, e.g., sulfuric acid (H₂SO₄) to obtain a solution comprising one or more value metal ions. The solution comprising one or more value metal ions may be further purified via, e.g., solvent exchange, ion-exchange, precipitation, extraction, and/or electrolysis.

Without wishing to be bound by theory, it is believed that the oxidized LFP battery material has beneficial properties for improving one or more downstream processes such as leaching. For instance, it is believed that the embrittlement of the oxidized LFP battery material may, e.g., result in smaller particles that have a more beneficial surface-to-volume ratio facilitating dissolution during acid leaching. The smaller particle size may additionally facilitate subsequent transport steps, such as conveying.

### EXAMPLE

The present disclosure will be explained in more detail below on the basis of an embodiment with reference to the accompanying drawing.

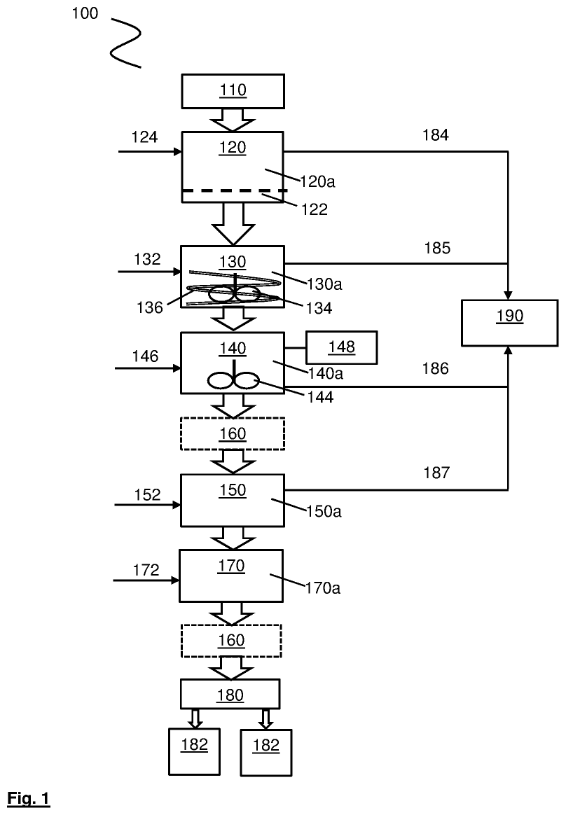

FIG. 1 is a schematic sketch of an embodiment of the plant for recycling LFP battery material of the present disclosure. The plant for recycling LFP battery material is denoted by the reference sign 100. The plant 100 comprises a comminuting device 120, an intermediate storage device 130, a drying device 140, a pyrolysis device 150, and an oxidation device 170.

The plant 100 is designed for batch-wise operation. In other words, a predetermined amount of LFP battery material, for example 100 kg of used LFP batteries, is supplied to the comminuting device 120 by an upstream dosing device 110, which is used to divide the delivered used LFP battery material into individual portions of the predetermined amount.

The comminuting device 120 can be equipped with a sieve device 122 on the outlet side, for example, a perforated plate with holes having a diameter of approximately 20 mm. In order to prevent environmentally incompatible gases from escaping from the comminuting device 120, said device is preferably gas-tight. In addition, the comminuting device 120 can be equipped with a supply line 124 for inert gas, via which inert gas can be supplied to the comminuting space 120a of the comminuting device 120, which reduces, if not completely excludes, the risk of self-ignition of the comminuted LFP battery material.

After a predetermined residence time in the comminuting device 120, the comminuted batteries are conveyed to the intermediate storage device 130. This intermediate storage device 130 is also preferably gas-tight. In addition, inert gas can also be supplied to the intermediate storage device 130 via a feed line 132 in order to be able to reduce, if not completely exclude, the risk of self-ignition of the comminuted batteries. The intermediate storage device 130 also has stirring means 134 which constantly mix the batteries received and comminuted in the intermediate storage space 130a in order to prevent the formation of partial volumes of excessive temperature. In the event that the temperature in the intermediate storage space 130a rises too much, the intermediate storage device 130 also has a cooling device 136, for example cooling coils through which cooling medium flows, which are attached to the outer boundary wall of the intermediate storage space 130a and are in heat-exchange contact therewith.

After the comminuted LFP battery material from a predetermined number of comminution processes have been received in the intermediate storage device 130, the intermediate storage space 130a is emptied in the direction of the drying device 140, the drying space 140a of which is preferably also gas-tight and which may also comprise stirring means 144. Furthermore, inert gas can also be supplied to the drying space 140a via a line 146.

In the embodiment shown, the drying device 140 is a negative-pressure drying device which dries the comminuted LFP battery material at a pressure of 50 hPa and at a temperature of at least 120° C. The pressure control and temperature control unit required for this purpose is denoted in FIG. 1 by reference sign 148.

After the comminuted batteries have been dried in the drying device 140, the drying space 140a is emptied in the direction of the pyrolysis device 150.

A screening device 160 can be arranged downstream of the drying device 140, in which screening device 160 the individual components of the comminuted and dried LFP battery material can be separated from one another and thus supplied to a more targeted processing. In principle, it is possible to arrange a plurality of screening stages one behind the other. In some embodiments, one of the screening stages comprises a simple sieve.

The pyrolysis device 150 receives the comminuted and dried and optionally screened LFP battery material in a pyrolysis space 150a, where they are subjected to a heat treatment under reducing conditions to obtain a pyrolyzed LFP battery material. Inert gas can also be supplied to the pyrolysis space 150a via a line 152.

The oxidation device 170 receives the pyrolyzed LFP battery material in an oxidation space 170a, where it is subjected to a heat treatment under oxidative conditions to obtain on oxidized LFP battery material. Oxygen-containing gas can be supplied to the oxidation space 170a via a line 172.

A screening device 160 can be arranged downstream of the oxidation device 170, in which screening device 160 the individual components of the oxidized LFP battery material can be separated from one another and thus supplied to a more targeted processing. In principle, it is possible to arrange a plurality of screening stages one behind the other. In some embodiments, one of the screening stages comprises a sieve. In some embodiments, the sieve is a vibrating sieve or vibrating screen.

Finally, the oxidized LFP battery material can be filled into transport containers 182 in a filling device 180.

It should also be noted that not only the comminuting device 120, the intermediate storage device 130, the drying device 140, and the pyrolysis device 150 can be made gas-tight, but also the transfer devices, which transfer the comminuted batteries from the comminuting device 120 to the intermediate storage device 130, from the intermediate storage device 130 to the drying device 140, and from the drying device 140 to the pyrolysis device 150, respectively.

It should also be noted that potentially environmentally hazardous gases formed in the comminuting device 120, the intermediate storage device 130, the drying device 140, and the pyrolysis device 150 can be supplied via lines 184, 185, 186, 187 to an exhaust gas treatment device 190 of a known type, in which they are processed in an environmentally friendly manner.

### EXAMPLES

### Examples 1-5

LFP battery waste was mixed with a one- or two-component earth alkaline F-scavenger (SCV) system in a stoichiometric ratio of 1.6:1-2.1:1 Fluoride to earth alkaline metal (F:M_{EA}). The compositions of the starting materials used are shown in Tables 1 and 2.

TABLE 1

| BM | C | F | Al | Cu | Fe | Li | Mg | P |
|---|---|---|---|---|---|---|---|---|
| 1 | 28.50% | 3.50% | 2.10% | 5.40% | 17.20% | 2.40% | 0.01% | 12.0% |
| 2 | 41.40% | 3.60% | 1.90% | 2.40% | 13.70% | 2.20% | 0.03% | 8.30% |

TABLE 2

| | | | SCV | | SCV | | | |
|---|---|---|---|---|---|---|---|---|
| Trial | BM | SCV 1 | 1 [g] | SCV 2 | 2 [g] | F:M_{EA} | F_{before} | F_{after} |
| I | 1 | / | / | MgO | 1.5 | 2.05:1 | 3.5% | 3.7% |
| II | 1 | CaCO₃ | 9.4 | / | / | 1.96:1 | 3.5% | 3.3% |
| III | 2 | CaCO₃ | 5.2 | MgCO₃ | 4.4 | 1.63:1 | 3.2% | 3.7% |
| IV* | 2 | / | / | / | / | / | / | / |
| V* | 1 | / | / | / | / | / | 3.5% | 0.3% |

*comparative examples

The material was placed into a quartz glass reaction vessel and was first heat treated under inert conditions at a temperature of 300-550° C. for 1-2 h and subsequently roasted under aerobic conditions at 500-550° C. for 1-2 h.

Fluoride remained quantitatively in the solid (>95%) in trials I-III. The conditions for trial IV were kept analogous except no additional scavenger was added. In trial V no scavenger was added, and the LFP battery waste material was heat treated under inert conditions at a temperature of 500° C. for 2 h. All products were obtained as a reddish brown solid.

### Leaching Example A

20 g of product I were dispersed in 92.5 g deionized water and heated to 100° C. under stirring. 7.5 g of 96% sulfuric acid were slowly added within 15 minutes. After 2 h at 100° C., the mixture was allowed to cool to ambient temperature and then filtrated to remove the solids. After washing with deionized water and drying under reduced pressure 18.8 g solid residue and 105.1 g leach solution could be obtained.

### Leaching Example B

20 g of product II were dispersed in 92.5 g deionized water and heated to 100° C. under stirring. 7.5 g of 96% sulfuric acid were slowly added within 15 minutes. After 8 h at 100° C., the mixture was allowed to cool to ambient temperature and then filtrated to remove the solids. After washing with deionized water and drying under reduced pressure 20 g solid residue and 103.8 g leach solution could be obtained.

### Leaching Example C

20 g of product III were dispersed in 110 g deionized water and heated to 100° C. under stirring. 10 g of 96% sulfuric acid were slowly added within 15 minutes. After 3 h at 100° C., the mixture was allowed to cool to ambient temperature and then filtrated to remove the solids. After washing with deionized water and drying under reduced pressure 19 g solid residue and 117.6 g leach solution could be obtained.

### Leaching Example D

20 g of product IV were dispersed in 110 g deionized water and heated to 100° C. under stirring. 10 g of 96% sulfuric acid were slowly added within 15 minutes. After 3 h at 100° C., the mixture was allowed to cool to ambient temperature and then filtrated to remove the solids. After washing with deionized water and drying under reduced pressure 18 g solid residue and 115.9 g leach solution could be obtained.

Leaching efficiencies measured are shown in Table 3, compositions of the leach solutions obtained are shown in Table 4.

TABLE 3

| Trial | Li-LE | Fe-LE | P-LE | F-LE | Mg-LE |
|---|---|---|---|---|---|
| A | 95.6% | 5.7% | 8.1% | / | 41.3% |
| B | 91.8% | 14.1% | 5.5% | / | / |
| C | 96.8% | 4.3% | 6.4% | 47.3% | 25.3% |
| D | 92.3% | 7.5% | 8.2% | 77.9% | / |

TABLE 4

| Trial | Li | Fe | P | Cu | F | Ca | Mg |
|---|---|---|---|---|---|---|---|
| A | 0.51% | 0.22% | 0.18% | 0.49% | n.d. | n.d. | 0.20% |
| B | 0.46% | 0.55% | 0.13% | 0.83% | n.d. | n.d. | n.d. |
| C | 0.39% | 0.11% | 0.10% | 0.48% | 0.29% | 0.049% | 0.064% |
| D | 0.41% | 0.21% | 0.14% | 0.53% | 0.47% | n.d. | n.d. |

### Analytical Methods

### Determination of Leaching Efficiencies

Leaching efficiencies (LE) were determined using element contents determined by ICP-OES. If not stated otherwise, leaching efficiencies were determined by using the element content determined in the mother liquor.

The following formulas were utilized:

$$\frac{m ( {E}_{ML} )}{m ( {E}_{Max} )} = {LE}_{E} \qquad ( 1 )$$

$$m ( {E}_{ML} ) = \frac{{E}_{ICP - ML} * m ( ML )}{100} \qquad ( 2 )$$

wherein
E denotes a given element,
ML denotes the mother liquor,
E_{ICP-ML} is the determined percentage-based content in the mother liquor,
m(E_{ML}) is the weight content of the element in the mother liquor,
m(E_{Max}) is the maximum yield of an element based on the amount of the element in the solid before leaching, and
LE_{E} is the leaching efficiency of the respective element.

In examples 2c, 2d, and 6b, the leaching efficiencies were determined from the filter residue.

All calculations are analogous to equations (1) and (2), except for substituting every instance of ML with FC (filter cake). The corresponding LE_{E} is:

$$1 - \frac{m ( {E}_{FC} )}{m ( {E}_{Max} )} = {LE}_{E} \qquad ( 3 )$$

### Proportion of Volatilized Fluorine

All calculations were performed using elemental contents determined by ICP-OES. Fluoride volatilization was either examined by analyzing fluorine content of the solid before and after thermal treatment, or by additionally analyzing fluorine content of the 10% KOH scrubber liquid.

$$\frac{m ( {F}_{Product} )}{m ( {F}_{Input} )} = {F}_{\%} \qquad ( 4 )$$

F % is then the percentage of fluoride in either the solid or the scrubber liquid, respectively.

### Elemental Analysis

This section describes the analytical methods used for the quantitative determination of the constituents of the composite material of the present disclosure.

### Fluorine Content

The determination of fluorine uses a combination of combustion and measurement by a fluoride ion-selective electrode.

### Combustion

Approximately 1-100 mg of the sample were weighed into a combustion boat. For sample weighing and transfer, a capsule made of gelatine or tin can be used. V₂O₅ was added to promote the combustion. The boat was introduced via a sample application device into a combustion tube heated to ˜1.000-1.100° C. The sample was combusted in an oxygen stream containing water steam. During combustion, fluorine containing components formed hydrogen fluoride. The combustion gases, containing the formed hydrogen fluoride, were absorbed in an absorption solution. A total ionic strength adjustment buffer, (e.g., TISAB IV buffer solution (ASTM D 1179)) was used as absorption solution. The solution was transferred to the ion-sensitive measuring cell and filled up to 50 mL using TISAB and ultrapure water (1:1).

The combustion system used was a Mitsubishi AQF-2100H automatic quick furnace (a1-envirosciences GmbH, 40595 Dusseldorf, Germany).
Oven inlet temperature: ˜1.000° C.
Oven outlet temperature: ˜1.100° C.
Combustion gas (oxygen): ˜200 mL/min
Carrier gas (argon): ˜100 mL/min
Water flow: 0.2 mL/min

### Detection by Fluoride Ion-Selective Electrode

In the absorption solution, fluoride was measured by means of a fluoride ion-selective electrode (e.g., ISE 6.0502.150, Deutsche Metrohm GmbH & Co. KG, 70794 Filderstadt, Germany). For quantification, external calibration of the electrode was performed using fluoride standard solutions of different concentrations, e.g. 0.1, 1.0, 10 and 100 mg/L fluoride. The calibration solutions were automatically prepared by diluting a fluoride stock solution with TISAB solution and ultrapure water (1:1).

### Metal Content

Elemental analysis was performed using a combination of acid dissolution and alkaline-borate fusion digestion with analysis by inductively coupled plasma optical emission spectrometry (ICP-OES) on an inductively coupled plasma optical emission spectrometer (e.g., Agilent 5110 ICP-OES, Agilent Technologies Germany GmbH & Co. KG, 76337 Waldbronn, Germany).

An aliquot (e.g., about 0.2 g) of the sample material was weighed into a volumetric flask and dissolved under slight heating with 30 ml HCl. After cooling down, the insoluble residue was filtered out and incinerated together with the filter paper in a Pt crucible above an open flame. Subsequently, the residue was calcinated at about 600° C. in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in deionized (DI) water under slight heating and 12 ml of HCl were added. Finally, the solution was joined to the initial filtered solution in the volumetric flask and topped up to its final volume with DI water. Each sample was prepared in triplicate. A blank sample was prepared in an analogous manner.

The digestion solution was analyzed by inductively coupled plasma-optical emission spectrometry (ICP-OES), using external calibration. For some samples, the digestion solution may be diluted before analysis, e.g., adapted to the concentration and calibration range of the respective analyte.

### Phosphorus Content

Phosphorus content was determined by a combination of acid dissolution and alkaline-borate fusion digestion with subsequent measurement via inductively coupled plasma optical emission spectrometry (ICP-OES).

An aliquot between 0.13 g and 0.18 g of the sample material was weighed into a volumetric flask and dissolved under slight heating with HCl (approx. 6 mol/l). After cooling down, the insoluble residue was filtered out and incinerated together with the filter paper in a Pt crucible above an open flame. Subsequently, the residue was calcinated at approx. 600° C. in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in DI water under slight heating and 12 ml of HCl were added. Finally, the solution was joined to the initial filtered solution in the volumetric flask and the volume was completed to 100 ml with DI water. Each sample was prepared in triplicate. A blank sample was prepared in an analogous manner.

The digestion solution was analyzed by inductively coupled plasma-optical emission spectrometry (ICP-OES) using and ICP-OES spectrometer (Agilent 5110 ICP-OES, Agilent Technologies Germany GmbH & Co. KG, 76337 Waldbronn, Germany) at wavelength: P (R) 178.222 nm, internal standard: Sc (R) 361.383 nm, Calibration: External, Dilution: 1 (direct measurement).

### Carbon Content

Carbon content was determined by elemental analysis in an automated analyzer (vario EL Cube, Elementar Analysensysteme GmbH, 63505 Langenselbold, Germany). The sample (2-3 mg) was weighed into a tin capsule. The capsule with the sample was combusted in a helium/oxygen atmosphere at approximately 1100° C. using copper oxide as combustion catalyst. After separation of the combustion gases via chromatography, carbon was determined as CO₂. The detection and quantification was performed via measurement of thermal conductivity using a TCD.

1. A plant for recycling lithium iron phosphate battery material, comprising:
a comminuting device configured to comminute the lithium iron phosphate battery material in a comminuting space;
an intermediate storage device arranged downstream of the comminuting device and comprising an intermediate storage space with stirring means;
a drying device arranged downstream of the intermediate storage device and comprising a drying space with stirring means;
a pyrolysis device, arranged downstream of the drying device, configured to pyrolyze the comminuted and dried lithium iron phosphate battery material in a pyrolysis space;
an oxidation device, arranged downstream of the pyrolysis device, configured to oxidize a pyrolyzed lithium iron phosphate battery material in an oxidation space; and
at least one screening device configured to separate individual components of the comminuted lithium iron phosphate battery material from one another.

2. The plant according to claim 1, wherein the comminuting device is equipped with a sieve device.

3. The plant according to claim 1, wherein the intermediate storage device is equipped with a cooling device.

4. The plant according to claim 1, wherein a screening device configured to separate individual components of the comminuted lithium iron phosphate battery material from one another is arranged upstream of the pyrolysis device.

5. The plant according to claim 1, wherein a screening device configured to separate individual components of the comminuted and the pyrolyzed lithium iron phosphate battery material from one another is arranged downstream of the oxidation device.

6. The plant according to claim 1, further comprising an exhaust gas treatment device connected to one or more of the comminuting space, the intermediate storage space, the drying space, and the pyrolysis space via respective gas supply lines and configured to process the gases formed in one or more of the comminuting space, the intermediate storage space, the drying space, and the pyrolysis space.

7. The plant according to claim 1, further comprising a filling device arranged downstream of the oxidation device.

8. The plant according to claim 1, wherein the pyrolysis device comprises a rotary kiln.

9. The plant according to claim 1, wherein the oxidation device comprises a rotary kiln.

10. A process for recycling lithium iron phosphate battery material comprising
a) providing the lithium iron phosphate battery material to a comminuting device,
b) comminuting the lithium iron phosphate battery material in the comminuting device,
c) transferring the comminuted lithium iron phosphate battery material into a drying device,
d) drying the comminuted lithium iron phosphate battery material,
e) transferring the comminuted and dried lithium iron phosphate battery material into a pyrolysis device,
f) heating the comminuted and dried lithium iron phosphate battery material to a temperature of from 400° C. to 630° C. while contacting the comminuted and dried lithium iron phosphate battery material with an inert gas and with a reductive gas generated in situ by thermal decomposition of the comminuted and dried lithium iron phosphate battery material to obtain a pyrolyzed lithium iron phosphate battery material; and
g) oxidizing the pyrolyzed lithium iron phosphate battery material at a temperature in a range of from 500° C. to 700° C. while contacting the pyrolyzed lithium iron phosphate battery material with an oxygen-containing gas to obtain an oxidized lithium iron phosphate battery material.

11. The process of claim 10, wherein step b) comprises the steps of:
I. feeding the material to a first comminuting device and comminuting the material to obtain first particles having a maximum diameter of 50 mm or less;
II. feeding the first particles obtained in step I) to a second comminuting device and comminuting the first particles to obtain second particles having a maximum diameter of 20 mm or less;
III. feeding the second particles obtained in step II) to a first separating device to remove a first fine fraction consisting of particles having a size of <500 μm from the second particles;
IV. feeding the second particles obtained in step III) to a third comminuting device and comminuting the second particles to generate a second fine fraction consisting of particles having a size of <500 μm; and
V. combining the first fine fraction and the second fine fraction.

12. The process of claim 10, wherein the lithium iron phosphate battery material comprises at least one selected from the group consisting of a lithium iron phosphate battery, lithium iron phosphate battery waste, lithium iron phosphate battery production scrap, lithium iron phosphate cell production scrap, lithium iron phosphate cathode active material, and combinations thereof.

13. The process of claim 10, wherein the lithium iron phosphate battery material comprises copper, aluminum, lithium, iron, phosphorus, or combinations thereof.

14. The process of claim 10, wherein the comminuted and dried lithium iron phosphate battery material comprises from 1 wt.-% to 50 wt.-% carbon, and/or from 0.1 wt.-% to 10 wt.-% aluminum, and/or from 0.5 wt. % to 7 wt.-% copper, and/or from 0 wt.-% to 11 wt.-% manganese, and/or from 1 wt.-% to 7 wt.-% lithium, and/or from 10 wt.-% to 35 wt.-% iron, and/or from 5 wt.-% to 20 wt.-% phosphorus, based on the total weight of the comminuted and dried lithium iron phosphate battery material.

15. A method of using the pyrolyzed lithium iron phosphate battery material produced by the process of claim 10, the method comprising recovering lithium and/or copper from the lithium iron phosphate battery material.
